(19) United States
(12) Patent Application Publication
(10) Pub. No.: US 2026/0051053 A1
(43) Pub. Date: Feb. 19, 2026

(54) SYSTEM

(71) Applicant: SOFTBANK GROUP CORP., Tokyo (JP)

(72) Inventor: Takafumi NARA, Tokyo (JP)

(73) Assignee: SOFTBANK GROUP CORP., Tokyo (JP)

(21) Appl. No.: 19/299,891

(22) Filed: Aug. 14, 2025

(30) Foreign Application Priority Data
Aug. 16, 2024 (JP) 2024-137326

(51) Int. Cl. G06T 7/00; G06N 3/0475

(52) U.S. Cl. CPC G06T 7/0012; G06N 3/0475; G06T 2207/10016

(57) ABSTRACT

A system includes a processor that acquires real-time video data of an animal, analyzes the acquired video data using a generative AI model, compares the analysis result with animal case data to determine the necessity of a veterinary visit, and notifies a user of the determination result.

### CROSS-REFERENCE TO RELATED APPLICATION

This application claims priority under 35 USC 119 from Japanese Patent Application No. 2024-137326 filed Aug. 16, 2024, the disclosure of which is incorporated by reference herein in its entirety.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, there has been an increasing demand for early detection and timely intervention for health issues in animals, particularly household pets. However, many pet owners lack the expertise to accurately recognize abnormal behaviors or early symptoms of illness in their animals. As a result, necessary veterinary visits may be delayed, leading to the progression or aggravation of the animal's condition, increased treatment costs, and negative impacts on the animal's well-being. There is a need for a system that enables owners to monitor their animal's health status easily and receive timely guidance regarding the necessity of veterinary consultation.

### SUMMARY

To address these problems, the present invention provides a system including a processor that acquires real-time video data of an animal, analyzes the acquired video data using a generative AI model, and compares the analysis result with animal case data to determine the necessity of a veterinary visit. The processor notifies the user of the determination result, and, when the necessity of a veterinary visit is high, further provides information of an animal hospital. The system may additionally transmit the video data and analysis result automatically to an animal hospital, enabling timely and efficient veterinary intervention.

“Real-time video data” means video information of an animal is captured and processed continuously or at short intervals to reflect the current status of the animal with minimal delay.

“Animal” means any non-human living creature, including but not limited to domestic pets such as dogs and cats, is a subject of monitoring by the system.

“Generative AI model” means an artificial intelligence model, such as a deep learning neural network, is capable of analyzing, interpreting, and generating features or patterns from video data in relation to animal behavior or condition.

“Animal case data” means a database or collection of previously recorded cases of animal symptoms, diagnoses, and behaviors is used as reference for comparison and determination.

“Processor” means an electronic data processing unit, including one or more CPUs or microcontrollers, executes programmed instructions to control the functions of the system.

“Veterinary visit” means a consultation or examination at a veterinary hospital or clinic is recommended or required for the animal.

“User” means the person who owns, cares for, or is responsible for the monitored animal and receives notifications or information from the system.

“Animal hospital” means a medical facility or clinic specializing in the diagnosis and treatment of animal health conditions, to which the system may refer or transmit information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions; and

FIG. 10 illustrates an emotion map mapping plural emotions.

FIG. 11 is a sequence diagram showing the flow of data processing system processing in Example 1.

FIG. 12 is a sequence diagram showing the flow of data processing system processing in Application Example 1.

FIG. 13 is a sequence diagram showing the flow of data processing system processing in Example 2.

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

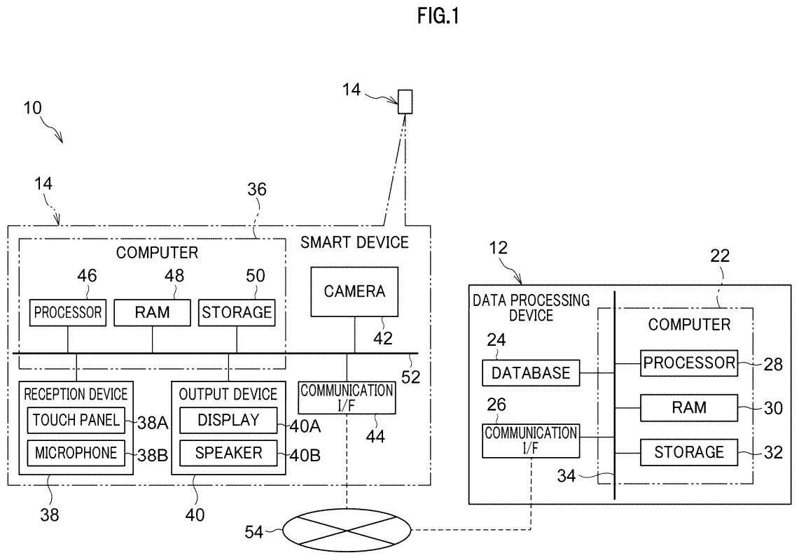

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

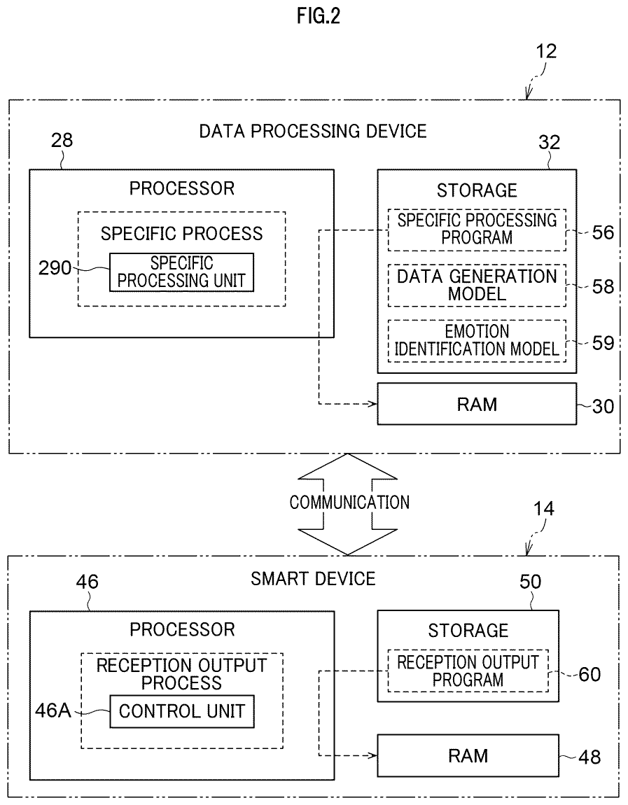

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In the field of animal care, it is difficult for owners to continuously and accurately monitor the health conditions and behavior of their pets or livestock in real time. This often results in both delayed detection of abnormalities—which may cause severe health deterioration—as well as unnecessary medical visits that lead to excessive financial burdens. Moreover, there is a need for a reliable method that enables prompt sharing of meaningful behavioral data and analytical results with veterinary facilities while protecting user consent and privacy.

The specific processing by the specific processing unit 290 of the data processing device 12 in Example 1 is realized by the following means.

The present invention provides a server including a processor configured to acquire image information representing a biological state, compress the acquired image information in predetermined time units and transmit the compressed image information via a communication network, store received image information in a storage unit, analyze the image information with a generative artificial intelligence model based on a machine learning algorithm to extract state features, compare the extracted features with case information to determine type and degree of abnormality, notify the user of the results, and, in accordance with user approval, securely transmit analysis results and image information to an external organization. This enables the reliable detection and timely notification of biological abnormalities, facilitates effective communication with medical institutions, and supports appropriate decision-making by the user while safeguarding privacy and optimizing healthcare resources.

The term “image information” refers to data representing visual characteristics of a biological subject, which is acquired through an image capturing device such as a camera. The term “biological state” refers to the current physical or behavioral condition of an animal or living organism as can be observed through image information.

The term “generative artificial intelligence model” refers to a computational model based on machine learning algorithms that is capable of analyzing data, extracting features, detecting patterns, and generating inferences, particularly relating to abnormalities in biological states.

The term “state features” refers to specific characteristics or attributes extracted from image information that represent behavioral or physical conditions of the biological subject. The term “case information data” refers to previously collected and categorized records of biological states and related abnormalities, which serve as reference patterns for comparison and diagnosis.

The term “external organization” refers to an entity outside the user's system, such as a medical institution or veterinary facility, which receives analysis results and image information for further action.

The term “user approval information” refers to data or signals indicating a user's explicit consent to share certain information with an external organization.

The term “secure communication channel” refers to a data transmission pathway protected by encryption or other security protocols to ensure confidentiality and integrity of the transmitted data.

The term “communication network” refers to infrastructure and protocols that enable electronic data exchange between the system's terminal device and remote server or processor.

The term “storage unit” refers to a hardware or virtualized memory system configured to store data, such as image information, for analysis or archival purposes.

The term “processing device” refers to a computational unit, such as a server or processor, responsible for performing data analysis, storage, comparison, and communication functions as specified by the system.

In an embodiment of the present invention, the system includes a terminal device configured to acquire image information representing the biological state of an animal. The terminal device, such as an embedded camera system, continuously monitors the animal, detects movement via an integrated sensor, and records video data. The terminal device is equipped with video compression software or a hardware JPEG encoder to compress video data in predetermined time intervals, such as every ten minutes. The terminal transmits the compressed image information to a remote server through a wireless communication module, such as Wi-Fi.

The server receives the compressed image information from the terminal and stores it in a storage unit, which may be implemented using a cloud storage service such as a general-purpose object storage solution. The server then executes a program written, for example, in Python, and leverages a generative AI model built on a machine learning framework such as TensorFlow or PyTorch. The generative AI model analyzes the stored image information, extracting relevant state features such as repetitive behaviors or physical abnormalities.

The server compares the extracted features with case information data, which are maintained in a structured database such as a relational database system using SQL. The server determines the type and degree of abnormality based on the comparison results. The server prepares a notification for the user according to the analysis, and sends a message to the user through a dedicated application, SMS, or email service.

When necessary, and upon receipt of explicit user approval via the dedicated application interface, the server transmits the analysis results and relevant image information to an external organization, such as a medical institution, using a secure communication channel (e.g., HTTPS protocol) in compliance with privacy and security requirements.

The described system can be constructed using general-purpose computer hardware, commercially available camera modules, memory, and communication equipment, and by implementing the described software components. This allows flexible deployment either locally or in a cloud computing environment.

As a concrete example, when the terminal device detects that a pet dog is exhibiting repetitive licking of a forepaw, it records and transmits the relevant video. The server's generative AI model processes the video and, upon detecting a pattern corresponding to potential dermatitis, notifies the user with a recommendation for veterinary consultation. The user can then approve sharing the analysis and video evidence with a veterinary facility so that appropriate action can be taken promptly.

An example of a prompt sentence for the generative AI model is as follows:

“Describe the design of a generative AI model for analyzing real-time pet video data to detect abnormal behaviors, and explain in detail how the user is notified of the results.”

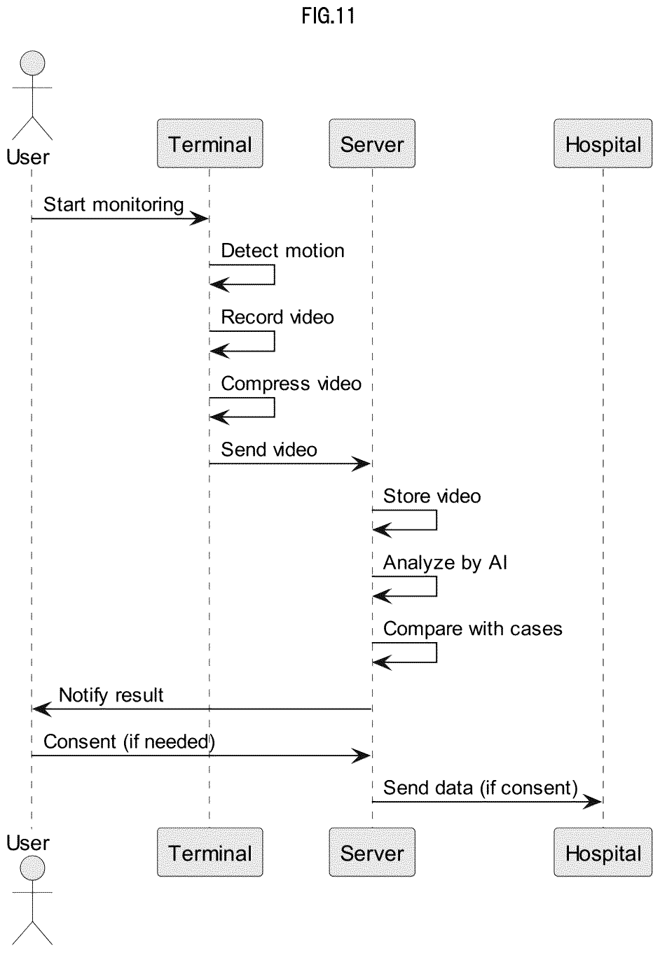

The following describes the processing flow using FIG. 11.

### Step 1:

The terminal detects movement of the animal using a built-in sensor and activates the camera to capture video footage.

Input: Real-time sensory signal indicating motion.

The terminal processes the sensor input and starts video recording, capturing image information as video data.

Output: Raw video data segments stored temporarily in buffer memory.

### Step 2:

The terminal compresses the captured video data at predetermined intervals, such as every ten minutes, using onboard video compression software or a hardware JPEG encoder. Input: Raw video data segments stored in the buffer.

The terminal encodes the video frames into a compressed format, reducing file size for efficient transmission.

Output: Compressed video data ready for transmission.

### Step 3:

The terminal transmits the compressed video data to the server via a wireless communication channel, such as Wi-Fi.

Input: Compressed video data.

The terminal establishes a network connection and uploads the data to a designated server endpoint.

Output: Compressed video data received at the server.

### Step 4:

The server receives the compressed video data and stores it in a storage unit, such as a cloud-based object storage system.

Input: Compressed video data transmitted from the terminal.

The server decodes the incoming data if necessary and writes it to long-term storage with proper indexing and time-stamping.

Output: Video data securely stored for subsequent analysis.

### Step 5:

The server executes a Python program that loads a generative AI model, such as a model built with TensorFlow, to analyze the video data.

Input: Stored video data from the storage unit.

The server processes video frames through the AI model, extracting behavioral and physical features, such as repeated paw licking or decreased movement.

Output: Extracted feature set and preliminary abnormality detection results.

### Step 6:

The server compares the extracted features with symptom case information in a structured database to determine a degree and type of abnormality.

Input: Extracted features from the AI model and case information data from the database.

The server performs database queries and pattern matching to classify the animal's condition as normal, mildly abnormal, or severely abnormal.

Output: Determined abnormality type and severity classification.

### Step 7:

The server generates and sends a notification to the user using a dedicated application, SMS, or email, depending on the user's preferences.

Input: Abnormality type and severity classification.

The server formats a message based on the condition detected and initiates a notification through the selected communication channel.

Output: Notification message delivered to the user's device.

### Step 8:

The user reviews the notification and, if prompted, provides consent via the application to share relevant data with an external medical institution.

Input: Notification message and user's action through the application interface.

The user evaluates the recommendation and interacts with the user interface to provide approval or rejection.

Output: User consent information generated and sent to the server.

### Step 9:

The server receives the user's consent, retrieves the relevant analysis results and video data, and transmits them to an external medical institution using a secure communication protocol such as HTTPS.

Input: User consent, analysis results, and video data.

The server packages the approved data and establishes a secure connection to the institution's endpoint, sending the necessary information for further action.

Output: Analysis results and image information delivered securely to the medical institution.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems for monitoring the health or status of biological bodies (such as animals or humans) using real-time image data often require significant manual intervention for data analysis and notification. Existing solutions lack efficient, automated means to detect abnormalities or symptoms from image data, determine the necessity of medical intervention, and promptly provide appropriate guidance or share results with healthcare providers. Furthermore, there is insufficient consideration for the emotional state of the user receiving such notifications, which can result in stress or ineffective communication.

The specific processing by the specific processing unit 290 of the data processing device 12 in Application Example 1 is realized by the following means.

The present invention provides a server including a processor configured to acquire real-time image data of a biological body, analyze the image data using a generative artificial intelligence model, input a prompt sentence for detection of abnormal behavior or symptoms, compare the analysis result with case data to determine the necessity of medical examination, estimate the user's emotional state, notify the user with appropriate guidance, and automatically share image data and analysis results with a medical institution if needed. This enables efficient and automated health monitoring, rapid and accurate abnormality detection, responsive user notifications tailored to the user's emotional state, and seamless cooperation with healthcare providers.

The term “image data acquisition unit” refers to a component or module configured to capture or obtain real-time image or video data of a biological body using an imaging device such as a camera or sensor.

The term “information analysis unit” refers to a component or module that processes and interprets acquired image data using computational methods, including analysis by a generative artificial intelligence model.

The term “generative artificial intelligence model” refers to a machine learning model, such as one employing deep learning, that can analyze input data and generate structured outputs including features, behaviors, or abnormalities related to the biological body.

The term “case data” refers to reference information that includes symptoms, medical histories, or example patterns about health conditions of biological bodies, stored for comparison with analysis results.

The term “determination unit” refers to a component or module configured to compare analysis results with case data in order to assess the presence or absence of abnormalities and determine the necessity of medical examination.

The term “information notification unit” refers to a component or module configured to inform or alert the user regarding the determination results through methods such as electronic mail, notification applications, or other communication means.

The term “prompt information generation unit” refers to a component or module that generates and inputs a formatted prompt sentence or instruction to the generative artificial intelligence model to specify detection objectives, such as abnormal behaviors or symptoms, during the analysis process.

The term “emotion estimation processing device” refers to a component or module configured to estimate the emotional state of the user based on user responses, biometric data, or behavioral input in order to tailor notification content appropriately.

The term “medical institution” refers to an organization that provides medical services, such as a hospital, clinic, or veterinary facility, to which image data and analysis results may be transmitted for further examination or intervention.

The term “information sharing unit” refers to a component or module configured to automatically transmit image data and analysis results to an external entity such as a medical institution, according to predetermined procedures or user consent.

The present invention can be implemented using a combination of hardware and software components in a system that enables automated health monitoring and abnormality detection for a biological body, such as an animal or human. The system includes a server that operates as a central processing unit, one or more terminals with imaging devices, and user access devices for receiving notifications.

The terminal is equipped with an image data acquisition unit, which may be realized using a digital camera or imaging sensor attached to commercially available smart devices or dedicated monitoring equipment. For example, the terminal can use a network camera or a built-in camera of a mobile device to constantly capture real-time image or video data of the target biological body. The terminal is programmed with software such as a Linux-based daemon or Python script utilizing OpenCV, which processes the imaging stream, segments relevant portions, and transmits these segments to the server through a network connection at periodic intervals.

The server receives the image data and stores it in a cloud-based storage solution, such as Amazon S3 or Google Cloud Storage, indexed and managed by a relational or NoSQL database system, such as PostgreSQL or Cloud Firestore. The server is configured to include an information analysis unit, which incorporates a generative artificial intelligence model implemented on a deep learning framework, such as PyTorch or TensorFlow. This generative AI model is trained to identify and extract features from the image data, such as recognizing specific behaviors, postures, or physiological symptoms of the biological body.

For analysis, the server prepares and applies a prompt sentence specifying the detection objective to the generative AI model. The prompt sentence can be dynamically generated based on system requirements or taken from a preset library of instructions. For instance, a typical prompt sentence may be:

“Analyze this image stream to detect any signs of abnormal behavior, injury, or illness in the target animal.”

During the analysis, the server utilizes the prompt information generation unit to ensure the generative AI model receives accurate and context-specific instructions. The analysis result from the AI model, containing recognized features or potential abnormalities, is then compared to case data stored in a medical or symptom database, using a determination unit. This comparison may reveal, for example, whether a detected behavior corresponds to a symptom of a particular disease or abnormal state, and allows the system to determine the necessity for medical examination.

Once a determination is made, the server notifies the user through information notification means, such as email (using services like SendGrid), SMS (using services like Twilio), or a dedicated mobile application (using push notification services like Firebase Cloud Messaging). The content of the notification is constructed based on the analysis and the determination result. The server can further utilize an emotion estimation processing device to assess the user's emotional state, possibly by analyzing their response pattern or biometric input. If a stressful state is detected, the notification message may be modified to provide reassurance or supportive instructions.

In some embodiments, when the determination unit identifies a high necessity for medical action, the server provides relevant information about nearby medical institutions, such as hospitals or clinics, based on the user's location information. Additionally, if user consent is obtained, the information sharing unit on the server automatically transmits relevant image data and analytical results to the specified medical institution for further assessment or pre-visit consultation.

As a concrete example, a pet monitoring camera (terminal) captures a dog's daily activity and regularly uploads video clips to the server. The server's generative AI model analyzes the videos using a prompt sentence such as:

“Analyze this pet video and identify if the animal is displaying excessive licking, limping, or any abnormal movement that may indicate a medical issue.”

If the AI model detects behaviors that correlate with known early signs of skin disease, the server compares this output against a symptom database. Should medical attention be deemed necessary, the server notifies the pet owner with a message including advice and local clinic information, tailoring the communication according to the detected emotional state of the user. This embodiment shows that the present invention enables automated, scalable, and user-sensitive health monitoring and abnormality detection by integrating hardware imaging devices, a server-based generative AI model, a prompt instruction system, case data evaluation, an emotion-aware notification process, and optional data sharing functions with medical institutions.

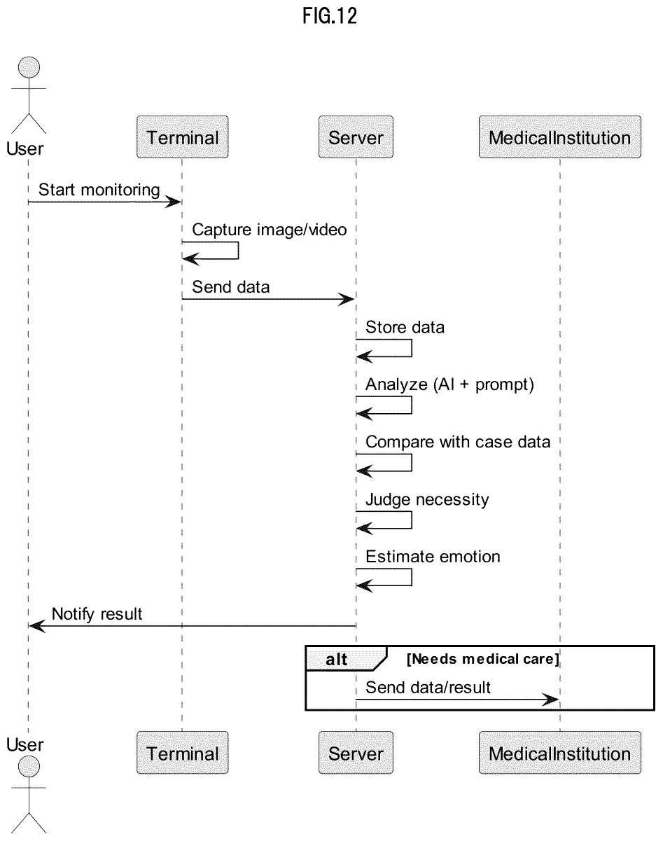

The following describes the processing flow using FIG. 12.

### Step 1:

The terminal captures real-time image or video data of the biological body using its imaging device.

Input: Live activity of the biological body in the monitored area.

Processing: The terminal, equipped with a camera and suitable software (such as a Python script using OpenCV), records continuous video or takes periodic images based on a specified interval, and stores the data temporarily in a local buffer.
Output: Buffered image or video data files.

### Step 2:

The terminal transmits the buffered image or video data files to the server via a secure network connection.

Input: Buffered image or video data files from Step 1.

Processing: The terminal compresses the data using a tool (such as FFmpeg), attaches timestamp and device identification information, and sends the data to the server via an HTTP POST request or other protocol.

Output: Compressed image or video data successfully delivered to the server.

### Step 3:

The server receives and stores the transmitted image or video data in a storage component.

Input: Transmitted image or video data including metadata from the terminal.

Processing: The server verifies the file integrity and source, then saves the files in cloud storage (such as Amazon S3 or Google Cloud Storage), updating a database (such as PostgreSQL) to index the files by device ID, user ID, and timestamp.

Output: Securely stored image or video data with associated metadata.

### Step 4:

The server selects the appropriate generative AI model, generates and applies a prompt sentence, and analyzes the image or video data.

Input: Stored image or video data, generative AI model, and dynamically or statically generated prompt sentence (e.g., “Analyze this image stream to detect any abnormal behavior or symptoms.”).

Processing: The server creates a prompt sentence, feeds both the image or video data and the prompt to the generative AI model (implemented in PyTorch or TensorFlow), and performs inference to extract features or identify abnormalities.

Output: Analysis result containing identified features, behaviors, or possible symptoms with confidence scores.

### Step 5:

The server compares the analysis result with case data to determine if medical intervention is necessary.

Input: Analysis result from the AI model and reference case data from a symptom or case database.

Processing: The server executes a comparison (such as feature matching or pattern recognition) between the recognized behaviors/symptoms and known medical cases to determine if an abnormal or risky condition exists.

Output: Determination result indicating the necessity of medical examination, and details of the condition where applicable.

### Step 6:

The server evaluates the user's emotional state and constructs a tailored notification message.

Input: Determination result from Step 5, and user context or historical response data.

Processing: The server runs an emotion estimation processing algorithm (possibly receiving behavioral or biometric input), determines if the user may be stressed or anxious, and adjusts the wording or content of the notification accordingly (e.g., additional reassuring phrases).

Output: Customized notification message.

### Step 7:

The server notifies the user via the selected communication channel and optionally provides additional information about relevant medical institutions.

Input: Customized notification message, user contact preferences, and determination result.

Processing: The server sends the notification to the user using the desired method, such as email, SMS, or push notification to a mobile application. If a high-necessity result is detected, the server appends information about nearby medical institutions.

Output: User receives the notification with appropriate guidance.

### Step 8:

Upon user consent, the server automatically transmits the relevant image or video data and analysis result to the designated medical institution.

Input: Analysis result, medical data, user consent, and institution contact information.

Processing: The server securely prepares the relevant files and results, transmits them to the medical institution via an approved API or file transfer protocol, and logs the transaction.

Output: Medical institution receives the data for further examination or pre-visit assessment.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional methods for monitoring the health status of animals are limited by the inability of owners to continuously and accurately detect abnormal behaviors or symptoms in their animals. Furthermore, even when an abnormality is noticed, it is challenging for owners to decide the appropriate timing for seeking veterinary care. There is also a lack of effective systems to support owners mentally by reducing stress when dealing with animal health issues and to efficiently share analysis results and relevant information with medical institutions prior to examination.

The specific processing by the specific processing unit 290 of the data processing device 12 in Example 2 is realized by the following means.

The present invention provides a server including a processor configured to acquire live video information of an animal, compress and transmit the information periodically via a communication network, store the information, analyze the information with a generative artificial intelligence model to detect abnormal animal behavior or symptoms, compare the detected features with case information, evaluate the necessity of medical intervention, provide notifications to the user, assess the user's psychological state and adjust messages accordingly, and transmit analysis results and video data to a medical institution with user consent. This enables real-time and accurate monitoring of animal health conditions, timely judgment of the necessity for medical consultation, reduction of user stress through adapted notifications, and efficient information sharing with medical institutions, facilitating rapid and precise veterinary care.

The term “processor” refers to a central processing unit or computational component configured to execute program instructions and perform data processing tasks within the system.

The term “live video information” refers to continuously captured image data of an animal in real time by an imaging device, including visual representations of animal behavior and surroundings.

The term “image acquisition module” refers to a hardware or software component configured to capture live video information from an imaging device.

The term “communication module” refers to a hardware or software component configured to transmit and receive data via a communication network, such as the internet. The term “storage module” refers to a hardware or software component configured to store data, including received video information and related data, in a memory device.

The term “generative artificial intelligence model” refers to a software-based analytical model utilizing machine learning or deep learning algorithms to process and analyze video information in order to extract features and detect patterns, including abnormal animal behavior or symptoms.

The term “deep learning framework” refers to a software platform or library that supports the development, training, and execution of deep neural networks, such as those used by the generative artificial intelligence model.

The term “feature information” refers to specific data points or characteristics extracted from video information which represent animal behaviors, actions, or physical conditions.

The term “case information” refers to reference data collected and stored in advance, including known symptoms, behaviors, or diagnosis outcomes associated with animal health conditions.

The term “medical intervention” refers to an action, treatment, or examination by a medical institution, in particular a veterinary medical procedure or consultation.

The term “notification module” refers to a hardware or software component configured to provide messages or alerts to the user regarding analysis results or recommended actions.

The term “user reaction information” refers to data representing how a user interacts with or responds to notifications, including feedback, response time, or emotional cues.

The term “psychological state” refers to the emotional or mental condition of a user, including stress, anxiety, or calmness, as determined from user reaction information.

The term “information sharing module” refers to a hardware or software component configured to transmit analysis results, video information, or related data to a medical institution, typically with security measures such as encryption.

The term “medical institution” refers to an entity that provides medical care to animals, such as a veterinary clinic or animal hospital.

The term “encrypted communication” refers to the transmission of information using protocols or methods that encode data to protect it from unauthorized access during transfer over a network.

One embodiment of the invention provides a system including a server, a terminal equipped with an imaging device, and a user interface device.

The terminal is configured to continuously acquire live video information that includes the animal's behavior using a camera. The terminal employs motion tracking techniques to automatically focus on the animal and collect behavioral data with high reliability. The camera is preferably a high-resolution digital video camera capable of H.264 video compression. The terminal is also equipped with a data processing module that divides the continuous video stream into predetermined intervals (for example, every 5 seconds) and temporarily stores the video segments in a buffer. At set intervals (for example, every 10 minutes), the terminal compresses the buffered video data using H.264 encoding and transmits the compressed video to the server via a communication module over a network using secure protocols such as HTTPS.

The server, containing at least one processor, receives the transmitted video information from the terminal and stores the data in a storage module. The storage module may be configured as a cloud storage solution, such as a generic cloud object storage service. The server logs video metadata, such as time, terminal ID, and data size, in a database for management and traceability.

For data analysis, the server utilizes a generative artificial intelligence model constructed and operated on deep learning frameworks such as a generic deep learning platform (e.g., TensorFlow or PyTorch). The server preprocesses the received video data by extracting frames, resizing images as necessary, and normalizing pixel values. The generative AI model analyzes the video to identify behavioral features—such as frequency, duration, and posture of the animal's actions—and detects abnormal behaviors or symptom patterns indicative of potential disease or injury conditions.

The server then compares the features extracted by the generative AI model to a case information database. This comparison is conducted using a relational database management system (e.g., SQL database), enabling efficient matching against previously collected examples of known symptoms, diseases, or case outcomes. On the basis of feature similarity, the server evaluates the probability that the animal's current behavior corresponds to a medical condition and determines the necessity of medical intervention. The evaluation result is categorized, for example, as “no abnormality,” “mild abnormality,” or “highly abnormal (immediate intervention recommended).”

The server is further equipped with a notification module that sends the evaluation outcome to the user via a dedicated application, SMS, or electronic mail, depending on user preference. When the server identifies a condition with a high necessity for medical intervention, the notification contains information such as nearby medical institutions or veterinary clinics, which can be retrieved using a generic mapping service API.

To support the user's mental well-being, the server is additionally provided with a psychological state evaluation function. This function uses a sentiment analysis API (such as a generic sentiment analysis service) to assess user reaction data—such as textual feedback or interaction latency—obtained via the user interface. Based on the user's emotional state (e.g., high stress), the server adjusts the notification message by appending supportive advice, such as “Please remain calm and consult your local veterinarian.”

Upon receiving the notification, the user can review the evaluation result through the user interface device. If the user consents to provide additional information to the veterinary institution, the server transmits the analysis result and a relevant segment of the video data to the medical institution through an information sharing module. During this process, transmission is encrypted using standard protocols such as SSL/TLS to ensure privacy and data security.

A concrete example of a generative AI model prompt sentence used in this embodiment is as follows:

“Analyze this video and detect if the animal is displaying abnormal behaviors such as excessive licking of its limbs or signs indicating possible inflammation. Categorize the severity and suggest if veterinary intervention is needed. Output results in structured sentences.”

In this embodiment, all components such as the terminal, server, data acquisition, data transmission, analysis, notification, and data sharing are implemented using widely available general-purpose hardware and software. Practical deployment can be achieved using a generic pet camera device, a cloud server infrastructure, and generic mobile or web-based user applications. Thus, persons skilled in the art can fully understand and practice this invention using the detailed description provided herein.

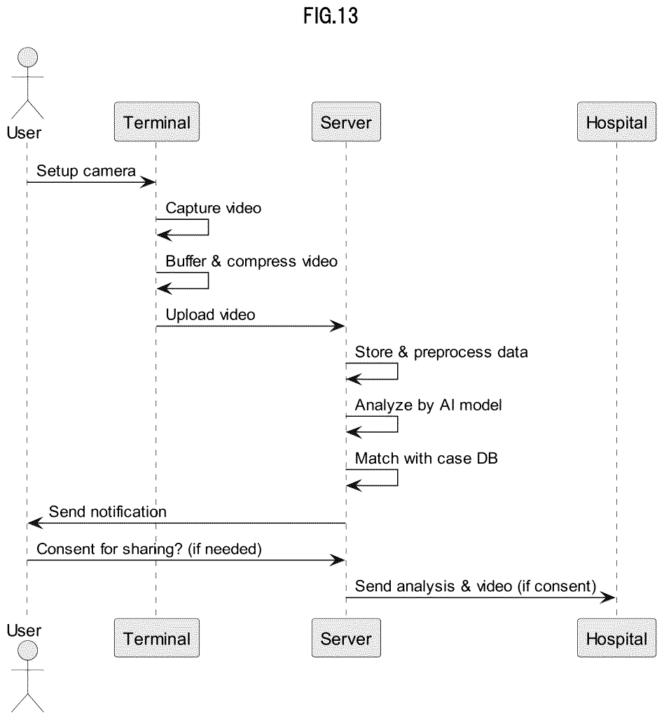

The following describes the processing flow using FIG. 13.

### Step 1:

The terminal activates its imaging device and continuously captures live video information of the animal in real-time. The input is the animal's environment; the output is a sequence of raw video frames temporarily buffered in the terminal. The terminal processes the video stream by dividing it into 5-second segments using an internal timer.

### Step 2:

The terminal aggregates the buffered 5-second video segments every 10 minutes. The input is the series of unsent video segments; the output is a batch of video files. The terminal employs H.264 video compression to reduce file size and then packages the compressed files into a data packet.

### Step 3:

The terminal establishes a secure connection via HTTPS and transmits the compressed video data packet to the server. The input is the compressed data packet; the output is a successful upload confirmation and the video data received by the server.

### Step 4:

The server receives the video data via the network and stores it in a storage module (such as cloud object storage). The input is the received compressed video data; the output is a stored file in the storage system and a log entry in a database containing metadata such as timestamp and terminal ID.

### Step 5:

The server preprocesses the video data by extracting individual frames, resizing images, and normalizing pixel values as needed. The input is the stored video file; the output is a sequence of prepared video frames suitable for analysis.

### Step 6:

The server applies a generative AI model, built upon a deep learning framework, to analyze the prepared frames with a defined prompt sentence (for example, “Analyze this video and detect if abnormal animal behaviors are present.”). The input is the sequence of video frames; the output is extracted feature information and detected patterns indicating behaviors or symptoms.

### Step 7:

The server compares the extracted feature information against a database of case information using a relational database system. The input is the feature information from the AI model and the case information database; the server performs similarity matching and probability computation. The output is an evaluated result indicating the necessity of medical intervention (such as “no abnormality,” “mild abnormality,” or “immediate intervention required”).

### Step 8:

The server prepares a notification for the user, selecting appropriate message templates based on the evaluated result, and retrieves user contact information. The input is the evaluated result, user profile, and message templates; the output is a notification message transmitted to the user via application, SMS, or email.

### Step 9:

The server collects reaction information from the user interface, such as feedback or response latency, after the user views the notification. The input is the user's reaction data; the output is an assessment of psychological state, performed by a sentiment analysis API.

### Step 10:

The server adjusts future notification content in accordance with the user's psychological state. If stress is detected, a supportive message is appended. The input is the psychological state assessment; the output is an adapted notification.

### Step 11:

If the user consents to share information with a medical institution, the server packages and encrypts the analysis result and related video data. The input is the user's explicit consent and relevant files; the output is the transmission of encrypted analysis data and video to the medical institution's endpoint, with confirmation of successful delivery.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional animal monitoring systems lack effective means to continuously detect and evaluate abnormal behaviors or symptoms in pets in real time. As a result, early signs of illness or health issues are often overlooked, leading to delayed medical intervention. Additionally, users face difficulties in receiving timely and appropriate advice tailored to both the pet's condition and their own emotional needs. Furthermore, there are insufficient opportunities for users to access products and services relevant to their pets' health through targeted advertisements based on the pets' detected condition.

The specific processing by the specific processing unit 290 of the data processing device 12 in Application Example 2 is realized by the following means.

The present invention provides a server including one or more processors configured to acquire real-time image data of an animal, periodically compress and transmit this data to an information processing device, analyze the image data using a generative artificial intelligence model to detect abnormal behaviors or symptoms, compare the results with a case database to determine the necessity of a medical institution visit, notify the user terminal device with the determination, analyze the user's emotional state and generate supplementary messages based on the state, and display targeted advertisements relating to the pet's health status or behavior. This enables early detection of pet health abnormalities, timely and emotionally appropriate notifications to the user, and improved accessibility to relevant products and medical services.

The term “image acquisition device” refers to any electronic device, such as a camera or sensor, capable of capturing real-time image or video data of an animal.

The term “storage device” refers to any form of data storage hardware, including but not limited to memory modules or disk drives, capable of storing digital information such as compressed image data.

The term “communication network” refers to any arrangement of hardware and software that enables the transmission of digital data between devices, including but not limited to the Internet, local area networks, or wireless networks.

The term “information processing device” refers to any computation resource, such as a server or computer, configured to receive, store, process, and analyze digital data.

The term “generative artificial intelligence model” refers to a machine learning or deep learning model that is trained to analyze, generate, or interpret complex patterns within input data, particularly for identifying animal behaviors or symptoms from image data.

The term “case database” refers to a structured collection of information about known animal symptoms, behaviors, and associated health conditions, used for comparison with newly analyzed data to assess health status.

The term “user terminal device” refers to any electronic device used by an end-user, such as a smartphone, tablet, or computer, that is capable of receiving notifications or displaying information.

The term “notification” refers to an electronic message or alert, sent to the user terminal device, that communicates information regarding the results of the image data analysis or health assessment of the animal.

The term “supplementary information” refers to additional content, such as comforting or encouraging messages, generated based on the user's emotional state and appended to notifications.

The term “advertising information” refers to electronic promotional content, such as banners or messages, presented to the user and related to the animal's detected health status or behavior.

The term “medical institution” refers to any veterinary service provider, clinic, or hospital that can provide diagnosis and treatment for animals.

The term “external information processing device” refers to a computing device outside of the user's premises, such as a server at a medical institution, that receives and processes shared data for further consultation or intervention.

An embodiment for implementing the present invention will now be described in detail.

A server includes a processor, a memory, a network interface, and may be connected to one or more image acquisition devices, such as digital cameras or smart sensors, capable of capturing real-time video or image data of an animal. The server is also capable of connecting to a storage device, such as a solid-state drive, to temporarily store the acquired image data. The server further interacts with a communication network, such as the Internet or a local wireless network, to transmit and receive data.

The server is configured to regularly acquire real-time image data from the image acquisition device. The acquired data is periodically compressed using standard video compression formats, such as H.264, and the compressed data is stored in the storage device before being uploaded over the network to the information processing device. The server can utilize open-source tools such as ffmpeg for the compression process.

On the information processing device, the server implements or invokes a generative artificial intelligence model for the analysis of the animal's behaviors and symptoms. This model may be constructed using deep learning libraries such as TensorFlow or similar machine learning frameworks. The generative artificial intelligence model is specifically trained to detect patterns corresponding to abnormal animal behaviors (such as excessive paw licking or limping) and infer probable symptoms from the video or image data.

The server then compares the detected behavior and symptom data with entries in a case database, which serves as a structured collection of known animal health cases and associated behavioral markers. This comparison allows the server to classify the animal's health state, for example into categories such as “normal,” “mild abnormality,” or “severe abnormality,” and to determine whether veterinary consultation is necessary.

Following the health state determination, the server generates a notification and sends it to the user terminal device, such as a smartphone or tablet. The notification includes the health assessment result. The server then analyzes the user's emotional state based on input, application usage, or biometric data, and generates a supplementary message (for example, a comforting or encouraging remark) to be appended to the notification.

Additionally, the server selects relevant advertising information based on the inferred health status or detected behaviors of the animal. This advertising content, which may promote animal health products or veterinary services, is transmitted to and displayed on the user terminal device in conjunction with the health status notification.

If necessary, the server can automatically transmit the compressed image data and the analysis results to an external information processing device of a veterinary medical institution for further professional assessment or consultation.

As a concrete example, an image acquisition device such as a network camera captures live video of a pet and transmits footage to the server every few seconds. The server compresses the video data using H.264, uploads the data to a cloud-based information processing system, and invokes a TensorFlow-based generative AI model to detect behaviors such as frequent paw licking. If the model and case database indicate that a symptom such as early dermatitis is present, the server sends a notification to the user's mobile device recommending veterinary consultation and appends a calming message if user stress is indicated. Simultaneously, the server delivers advertisements for relevant products, such as animal skin care items or local veterinary facilities, to the mobile interface.

An example of a prompt sentence used for the generative AI model in this system is: “Obtain real-time video data of pets using a camera, analyze it with a generative AI model to detect abnormal behaviors, match the analysis with case data to determine if veterinary attention is needed, and notify the user. Evaluate the user's emotions to append appropriate messages and display related advertisements for pet health services.”

By employing widely available computing hardware, standard software components, and machine learning models, those skilled in the art can implement this invention according to the above embodiment.

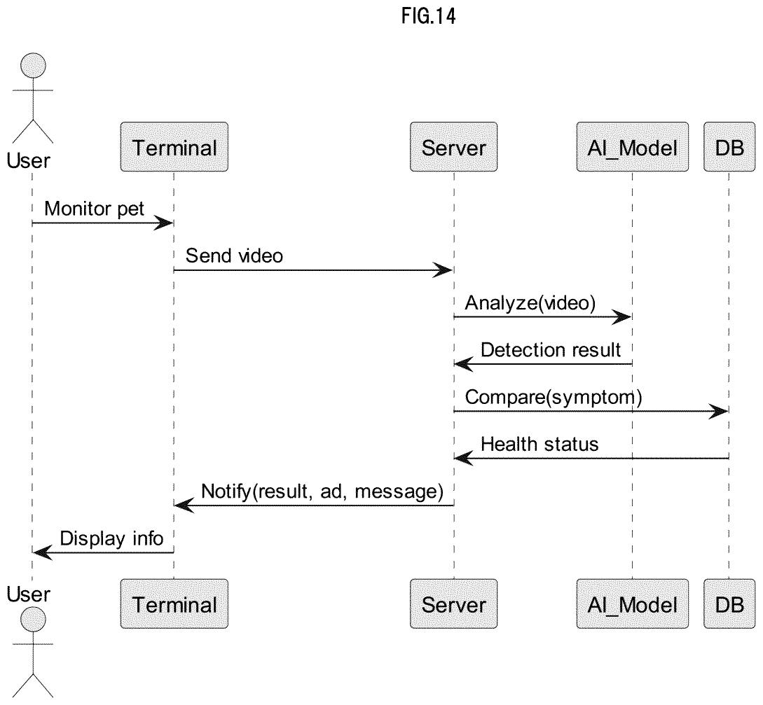

The following describes the processing flow using FIG. 14.

### Step 1:

The server receives real-time video data from the image acquisition device placed in the user's environment. The input is a live video stream captured by a digital camera or sensor. The server processes the incoming stream by extracting video frames every few seconds and temporarily stores the frames in a buffer within the server's memory. The output is a sequence of buffered short video clips representing the animal's activity over a defined period.

### Step 2:

The server periodically compresses the buffered video clips using a standard codec, such as H.264. The input is the set of uncompressed short video clips from the server's buffer. The server invokes a software compression tool to reduce file size, converting raw clips into compressed video files. The output is a compressed video file containing footage from a specific duration, such as 10 minutes.

### Step 3:

The server uploads the compressed video file to the information processing device over a communication network, such as the Internet. The input is the compressed video file generated in Step 2. The server uses a secure network protocol (e.g., HTTPS) to transmit the file to a remote storage location or cloud server. The output is the successful delivery and storage of the compressed video on the information processing device.

### Step 4:

The server analyzes the received compressed video using a generative AI model, such as a deep learning model created with TensorFlow. The input is the compressed video file stored on the cloud or server. The server decodes the video, extracts visual features, and applies the AI model to identify behavioral patterns, such as abnormal movements or repetitive actions of the animal. The output is a set of extracted features, labeled behaviors, and their corresponding probability scores.

### Step 5:

The server compares the detected behaviors and symptom data with those stored in the case database. The input is the labeled behavior data and scores from the AI model in Step 4. The server queries the database for matching symptom patterns and applies logic to determine the health state of the animal and whether a veterinary visit is recommended. The output is a classification result, such as “normal,” “mild abnormality,” or “severe abnormality,” along with any recommendations for veterinary care.

### Step 6:

The server generates a notification message for the user and sends it to the user's terminal, such as a smartphone. The input is the health assessment and recommendation result from Step 5. The server formats a notification that includes assessment details and, when required, information about nearby veterinary facilities. The output is a notification payload delivered to the user's terminal device.

### Step 7:

The server evaluates the user's emotional state using user interaction history, biometric cues, or sensor input if available. The input is data related to the user's behavior or responses within the app. The server processes the emotional data using an emotion analysis engine and selects an appropriate supplementary message (for example, a comforting or encouraging phrase). The output is a complete notification that includes both the health assessment and the supplementary message.

### Step 8:

The server selects and transmits advertising information that is relevant to the detected health status or behaviors of the animal. The input is the classification result from Step 5 and advertisement database entries. The server matches the pet's detected condition to the relevant advertisements for preventative health products or services. The output is an advertisement payload sent to the user's terminal.

### Step 9:

The terminal receives notifications and advertisement payloads from the server and displays them to the user. The input is the notification and advertisement content from the server. The terminal displays a pop-up, a banner, or another alert format with the health status, supplementary message, and any related advertisements. The output is a graphical user interface that presents this combined information to the user.

### Step 10:

The server, when necessary, automatically transmits the compressed video file and analysis results to an external information processing device of a veterinary institution. The input is the video and assessment data from earlier steps. The server uploads the data securely to the external institution to facilitate remote review or expert consultation. The output is the external institution's receipt of the data, which can be used for professional diagnosis or support.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

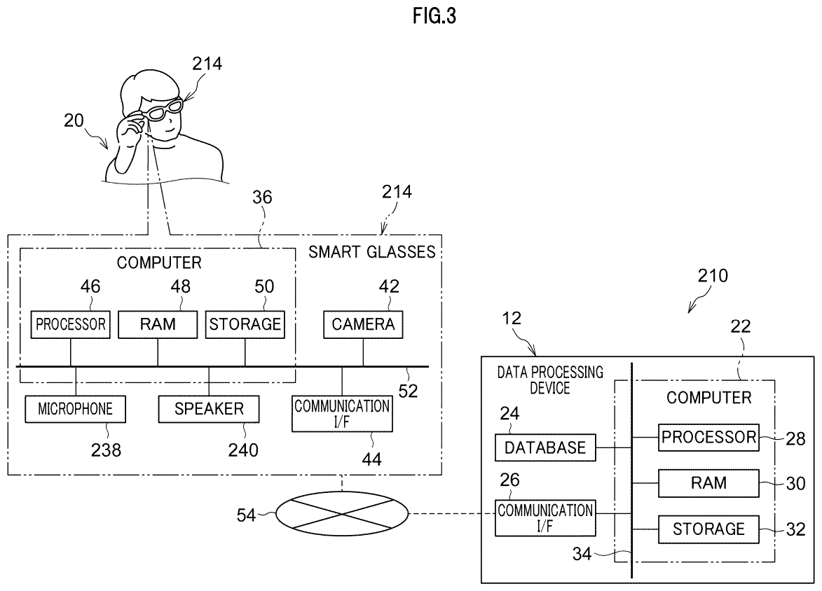

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

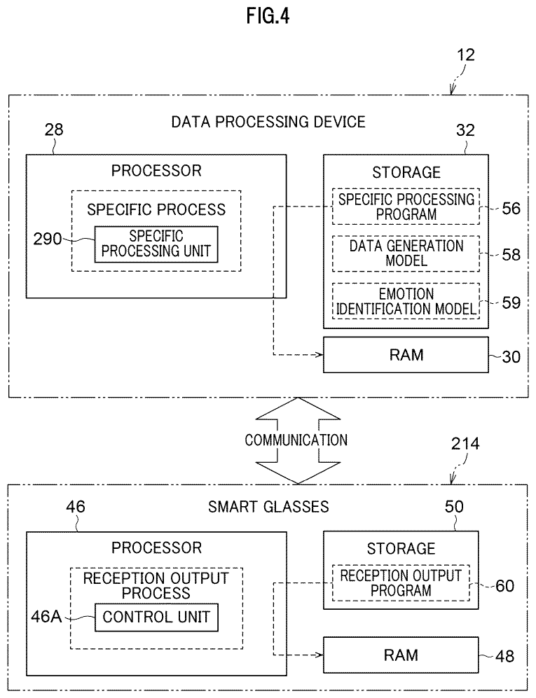

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

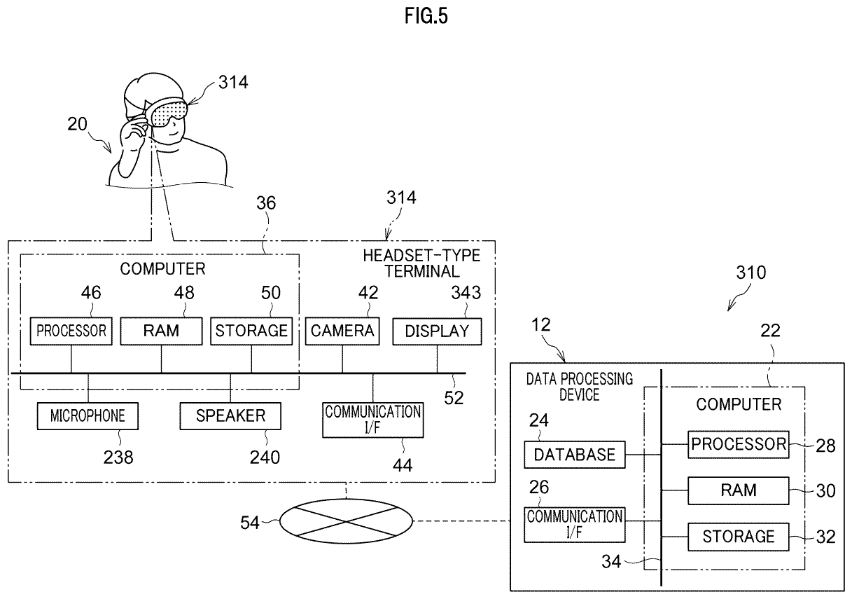

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

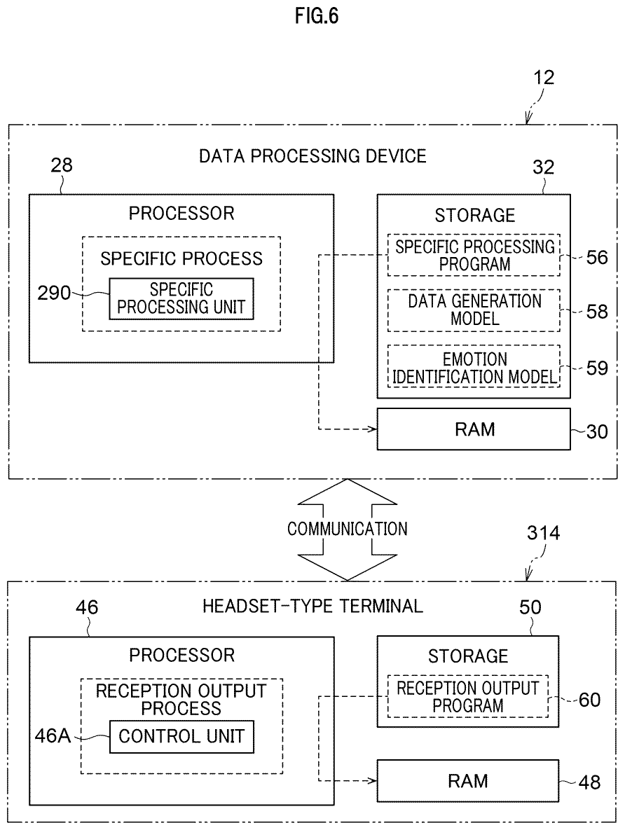

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

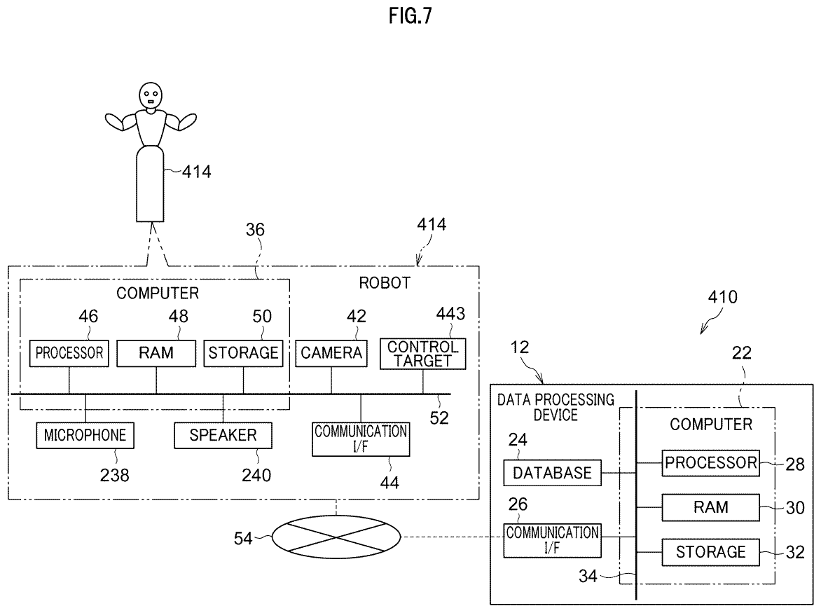

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

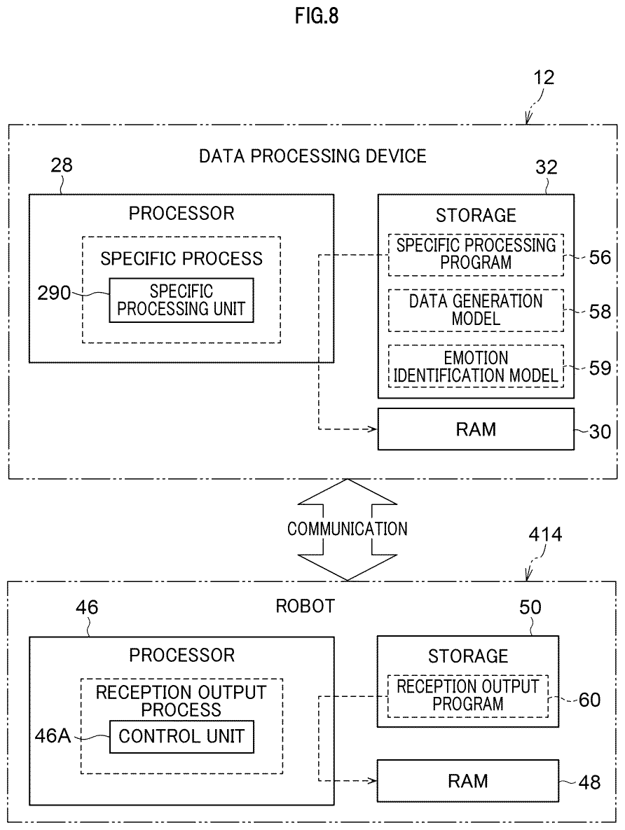

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

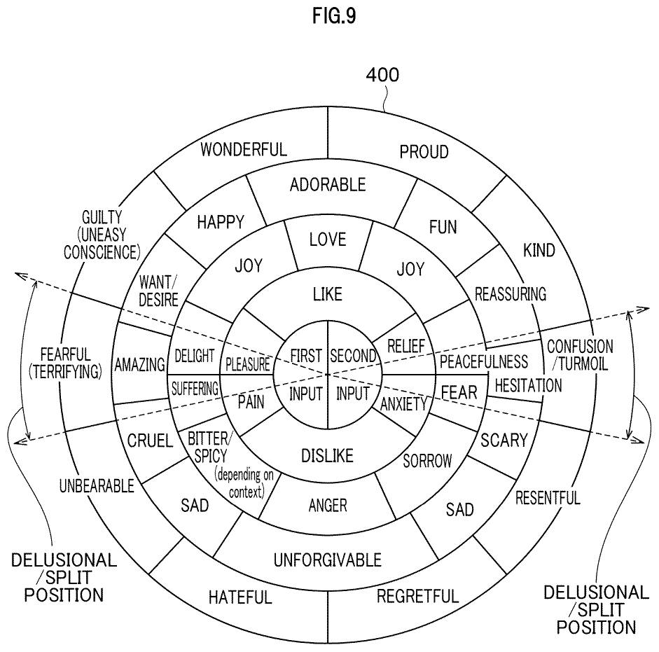

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

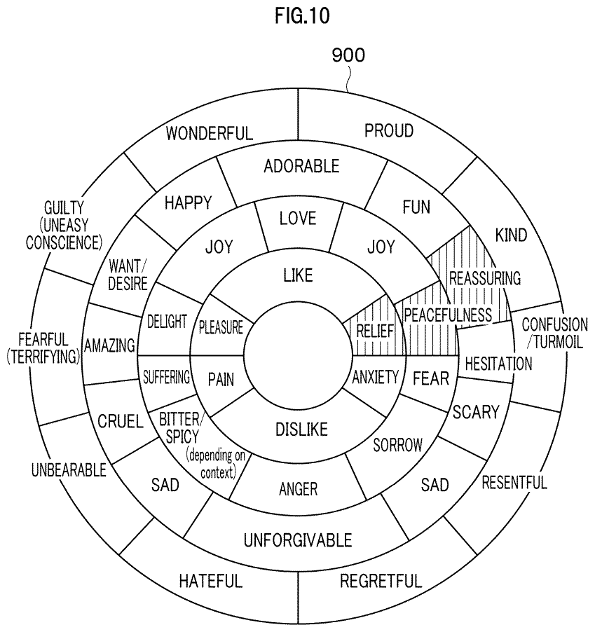

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system including a processor,
wherein the processor is configured to:
acquire image information representing a biological state,
compress the acquired image information in predetermined time units and transmit the compressed image information to a processing device via a communication network,
store the received image information in a storage unit and analyze the image information using a generative artificial intelligence model based on a machine learning algorithm to extract predetermined state features,
compare the extracted state features with a plurality of case information data and determine a type and degree of abnormality regarding the biological state,
notify a user of the presence of abnormality or proposed responsive action based on a result of the determination, and
according to a user's approval information, transmit at least the analysis result and the image information to an external organization via a secure communication channel.

### (Supplementary 2)

The system according to supplementary 1,
wherein the processor is configured to:
provide the user with related information on an external medical institution in a case where the result of the determination by the processor exceeds a predetermined threshold.

### (Supplementary 3)

The system according to supplementary 1,
wherein the processor is configured to automatically transmit the analysis result and the image information to an external medical institution in response to obtaining approval from the user.

### Application Example 1

### (Supplementary 1)

A system including a processor,
wherein the processor is configured to:
acquire real-time image data of a biological body using an image data acquisition unit,
analyze the acquired image data using an information analysis unit including a
generative artificial intelligence model,
compare an analysis result obtained by the information analysis unit with case data to determine a necessity of medical examination using a determination unit,
notify a user of a determination result by an information notification unit,
input a predetermined format prompt sentence to the generative artificial intelligence model for detection of abnormal behavior or symptoms during analysis by the information analysis unit using a prompt information generation unit, and
estimate an emotional state of the user using an emotion estimation processing device.

### (Supplementary 2)

The system according to supplementary 1,
wherein the processor is configured to provide information of a medical institution when the necessity of medical examination is determined to be high by the determination unit.

### (Supplementary 3)

The system according to supplementary 1,
wherein the processor is configured to automatically transmit the image data and analysis result to a medical institution using an information sharing unit.

### Example 2

### (Supplementary 1)

A system including a processor,
wherein the processor is configured to:
acquire live video information including animal behavior by an image acquisition module,
periodically compress and transmit the live video information through a communication module via a network,
store the received video information in a storage module,
analyze the stored video information by a generative artificial intelligence model implemented with a deep learning framework, extract feature information of the animal, and detect abnormal behavior or symptoms,
compare the extracted feature information with previously collected case information and evaluate the necessity of medical intervention based on the comparison result,
provide notification of the evaluation result and related information to a user by a notification module,
evaluate the psychological state of the user based on user reaction information at the time of notification, and adjust the notification content according to the evaluation result, and
transmit the analysis result and related information to a medical institution automatically with user consent by an information sharing module.

### (Supplementary 2)

The system according to supplementary 1, wherein the processor is configured to provide location information regarding the medical institution to the user when a high necessity of medical intervention is evaluated.

### (Supplementary 3)

The system according to supplementary 1, wherein the processor is configured to automatically transmit the analysis result and video information to the medical institution by encrypted communication.

### Application Example 2

### (Supplementary 1)

A system including a processor,
wherein the processor is configured to:
acquire real-time image data of an animal using an image acquisition device;
periodically compress the acquired image data, store it in a storage device, and transmit it to an information processing device via a communication network;
analyze the acquired image data using a generative artificial intelligence model to detect abnormal behaviors or symptoms of the animal;
compare the analysis results with a case database, evaluate the health status of the animal, and determine the necessity for a medical institution visit;
notify a user terminal device of the determination result;
analyze a user's emotional state in the course of notification, generate supplementary information such as a comforting or encouraging message based on the emotional state, and append the supplementary information to the notification content; and
based on the analysis results, display advertising information related to the animal's health status or behavior on the user terminal device.

### (Supplementary 2)

The system according to supplementary 1, wherein the processor is configured to provide, when a visit to a medical institution is determined to be necessary, positional information or contact information about a predetermined medical institution to the user terminal device.

### (Supplementary 3)

The system according to supplementary 1, wherein the processor is configured to automatically transmit and share the compressed image data and the analysis results to an external information processing device of a medical institution.

What is claimed is:

1. A system comprising a processor,
wherein the processor is configured to:
acquires real-time video data of an animal;
analyzes the acquired video data using a generative AI model;
compares the analysis result with animal case data to determine the necessity of a veterinary visit; and
notifies a user of the determination result.

2. The system according to claim 1, wherein the processor is configured to provide information of an animal hospital when the necessity of a veterinary visit is determined to be high by the comparison.

3. The system according to claim 1, wherein the processor is configured to further transmit the video data and analysis result automatically to an animal hospital.
